(19) United States
(12) Patent Application Publication
(10) Pub. No.: US 2007/0033157 A1
(43) Pub. Date: Feb. 8, 2007

(54) Transaction protection in a stateless architecture using commodity servers

(75) Inventor: Daniel Bryan Gray, Houston, TX (US)

Correspondence Address: WONG, CABELLO, LUTSCH, RUTHERFORD & BRUCCULERI LLP, 20333 SH 249, SUITE 600, HOUSTON, TX, 77070, US

(73) Assignee: SimDesk Technologies, Houston, TX (US)

(21) Appl. No.: 11/272,375

(22) Filed: Nov. 11, 2005

Related U.S. Application Data
(60) Provisional application No. 60/706,334, filed on Aug. 8, 2005.

(51) Int. Cl. G06F 17/30

(52) U.S. Cl. 707/1

(57) ABSTRACT

A system where commodity hardware can be utilized to act at least as a front-end to a database system, while maintaining transaction commitment reliability. A separate table to track if a transaction has been previously committed is provided. Preferably this separate stateless transaction protocol (STP) table utilizes indices relating to the user and to the particular request to determine if the particular transaction has been previously committed. By inspecting this table prior to providing the transaction to the primary transaction database, a determination can be made whether the transaction has been previously committed. If so, the response, which is stored in the STP table, is simply provided. If not, then the transaction is committed and an entry is made in the STP table to indicate the commitment. In the preferred embodiment the primary transaction database table entries and the entry into the STP table are committed with the same transaction.

### CROSS REFERENCE TO RELATED APPLICATIONS

This application claims the benefit under 35 U.S.C. § 119(e) of U.S. Provisional Patent Application Ser. No. 60/706,334, entitled “Transaction Protection Using Commodity Servers” by Daniel B. Gray and Paul Busch, filed Aug. 8, 2005, which is hereby incorporated by reference.

### BACKGROUND OF THE INVENTION

1. Field of the Invention

The invention relates to transactions provided over a network, and more particularly to reliable storage of those transactions provided over a network.

2. Description of the Related Art

Transactions over the Internet are rapidly increasing. Not only do shopping sites utilize transactions, but many other sites do as well to provide and maintain data. However, one problem with transactions that are accomplished over networks such as the Internet is the reliability of the transaction process itself. In many cases it is not acceptable to allow a transaction to be posted twice, which can occur if the transaction is actually posted but the client or originator never receives the posted response and repeats the transaction. Because of this problem, sophisticated techniques have been developed to prevent the double posting and often expensive and sophisticated computer hardware is required.

Generally it has been considered required that full state tracking be performed for each transaction, so that should any loss of responses or other communication occur, the exact state of the transaction can be determined. However, this requires that state be maintained by both the client and server ends.

One alternative would be a stateless environment where clients resubmit any transaction after error detection. However, a stateless environment increases the double posting problem discussed above. In those cases, to be more reliable it is preferred that the transactions and the database be located on the same logical unit, either an individual unit or a cluster. Exemplary systems include various mainframes, Hewlett-Packard NonStop servers and Oracle clusters. The problem with this is that those systems are very expensive. This is exacerbated in larger systems. Some cost reductions can be obtained by separating the server into two portions, a transaction front end and a database back end. But both of these portions must still be clustered or redundant systems as listed above to have the needed reliability, so the cost reduction is not necessarily very large.

This is in contrast to commodity servers, such as those built using Intel architectures and running unreliable or non-fault tolerant operating systems such as Linux or Windows. But the Linux and Windows commodity hardware systems running the less scalable and non-fault tolerant databases such as MySQL, Postgres or SQL Server, simply cannot provide the type of data integrity needed to handle the high reliability transaction systems. Therefore the only practical alternative has been either to forgo the stateless architecture of transactional reliability and use other techniques which are not as acceptable, or to utilize an expensive hardware environment.

It would be desirable to be able to perform the reliable commitment of transactions in a stateless architecture using less expensive hardware to enable higher throughput for a lower cost, while maintaining the high reliability and eliminating the duplication of transactions.

### SUMMARY OF THE INVENTION

In a system according to the present invention, commodity hardware can be utilized to act as a front-end to a database system, while maintaining transaction commitment reliability in a stateless architecture. Systems according to the present invention utilize a separate table to track and determine if a particular transaction has been previously committed to the primary transaction database. Preferably this separate table, the stateless transaction protocol (STP) table, utilizes indices relating to both the user and to the particular request to determine if the particular transaction has been previously committed and if a response has been provided for that transaction. By inspecting this table prior to actually starting any transaction to the primary transaction database, a determination can be made whether the transaction has been previously committed to the primary transaction database. If so, the response, which is also stored in the STP table, is simply provided and the original transaction is no longer necessary. However, if the STP table does not indicate that the transaction has been previously committed, then the transaction is committed and an entry is made in the STP table to indicate the commitment. In the preferred embodiment the primary transaction database table entries and the entry into the STP table are protected by the same transaction, thus alleviating potential race conditions.

By utilizing this separate table to track prior commitments of transactions, less reliable and yet significantly cheaper, commodity server hardware can be utilized at least as a front-end connected to the clients to reduce overall cost of the computer system. In certain embodiments the database server itself can be a commodity server with a commodity database instead of a mainframe or similar as in the prior art.

### BRIEF DESCRIPTION OF THE DRAWINGS

FIGS. 1A and 1B are descriptions of transaction database systems according to the prior art.

FIG. 2 is a first embodiment of a transaction database system utilizing commodity hardware according to the present invention.

FIG. 3 is a second embodiment of a transaction database system using commodity hardware according to the present invention.

FIG. 4 is a third embodiment of a transaction database system utilizing commodity hardware according to the present invention.

FIGS. 5A and 5B are a flowchart of a reliable commit process according to the present invention.

FIG. 6 is an illustration of a table used in the process of FIGS. 5A and 5B.

### DETAILED DESCRIPTION OF THE PREFERRED EMBODIMENT

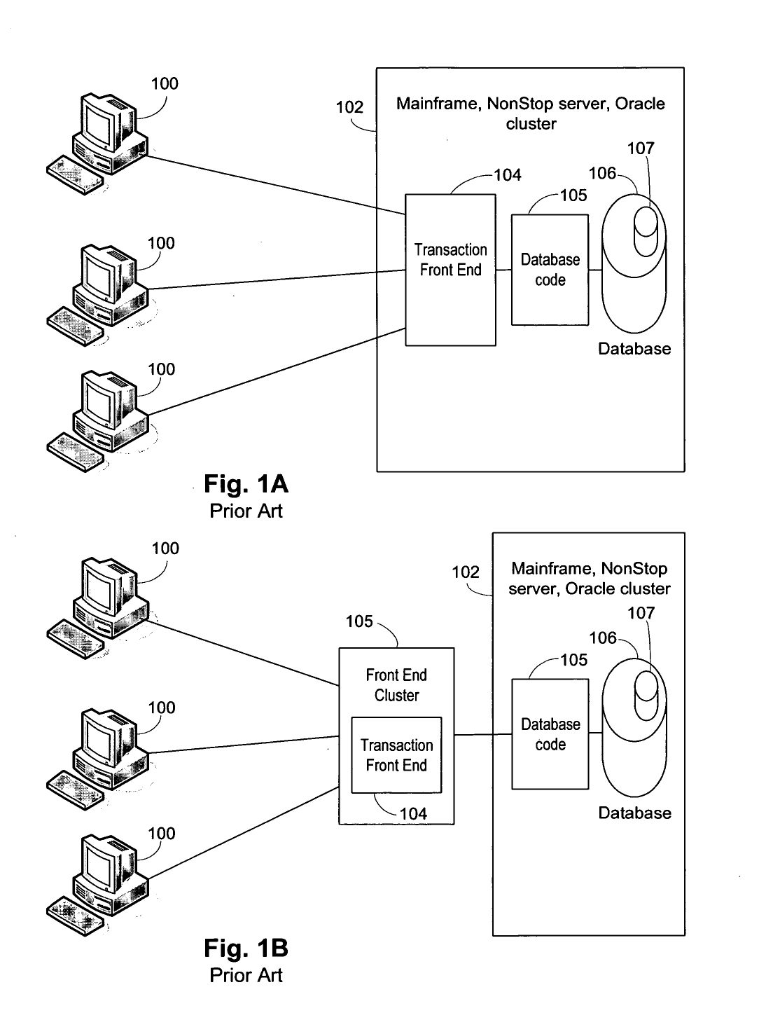

FIG. 1A is an illustration of the prior art transaction database system. Clients 100 are connected to a mainframe/NonStop server/Oracle cluster 102 (hereafter just referred to as mainframe for simplicity). Software running inside the mainframe 102 includes a transaction front-end module 104, a database code module 105 and a database 106, such as a mainframe database, SQL/MX or Oracle (hereafter, mainframe database), which contains the data tables 107 relevant to the transaction. The clients 100 communicate with the transaction front-end module 104 for communication purposes and then the transaction front-end module 104 communicates with the database code module 105, which in turn communicates with the database 106 to actually commit and store the transactions. It is understood that the database code module 105 may be an integral portion of the database 106, but for ease of understanding this invention, the database has been separated into database code modules, which perform pre- and post-processing functions, and the database core, styled the database 106, which performs the actual table entries and lookups.

In normal operation it is possible that the response from the transaction front-end 104 to the client 100 after commitment of a transaction, i.e., after the write operation has actually occurred in the database 106, can be lost. In most cases where the response is not received, the client 100 will retry the response, which would then commit yet one more write operation to the database 106, thus providing duplicate entries. This is the condition which is to be avoided.

Part of the problem with this prior art stateful mainframe architecture is that as the number of clients, and thus transactions increases, the number of modules necessary in the mainframe 102 increases rather dramatically. As much of the capacity is being utilized to perform the communication operations by the transaction front-end module 104, this is not considered to be the most efficient use of the mainframe 102. Thus, to handle very large volumes of operations, very large costs must be incurred to maintain the stateful architecture. The question that arises is why not simply take the transaction front-end 104 out of the mainframe 102 to help reduce cost? According to the stateful protocols of the prior art, that does nothing more than provide one more potential for a response failure, i.e., between the database code module 105 and the transaction front-end module 104 if it is separated into a different unit. Thus it would only potentially exacerbate the problem as more states would need to be tracked, not solve the problem.

This scalability and reliability can be partially addressed by moving the transaction front end module 104 to a separate front end cluster 105 as shown in FIG. 1B. But because the move is still to a cluster, scaling is still limited to the cluster limit and the cost per transaction is still high due to the redundant nature of the cluster.

A system according to the present invention is shown in FIG. 2 which does have the transaction front-end modules 104 moved externally without clustering, thus providing the greatest scalability at the lowest cost. Two clients 100 are linked to a commodity hardware server 108 which is running the transaction front-end module 104. A third client 100 is connected to a second commodity hardware server 110, which is also running the transaction front-end module 104. Preferably these commodity hardware servers 108 and 110 are running the Linux operating system, though Windows or other operating systems could be utilized if desired. The commodity servers 108 and 110 and the front-end modules 104 are then connected to a mainframe 112 which, as before, is running the mainframe database 106. A different database code module 111, which receives the communications from the front-end modules 104 and communicates with the database 106, is running in this embodiment. The difference between this and a potential architecture according to the prior art is that the protocol utilized in the database code module 111 has been altered to ensure that duplicate transitions do not develop. This will be described in more detail below. In addition, a new stateless transaction protocol (STP) table 113 is present in the database 106. It cooperates with the database code module 111 and will be described in more detail below.

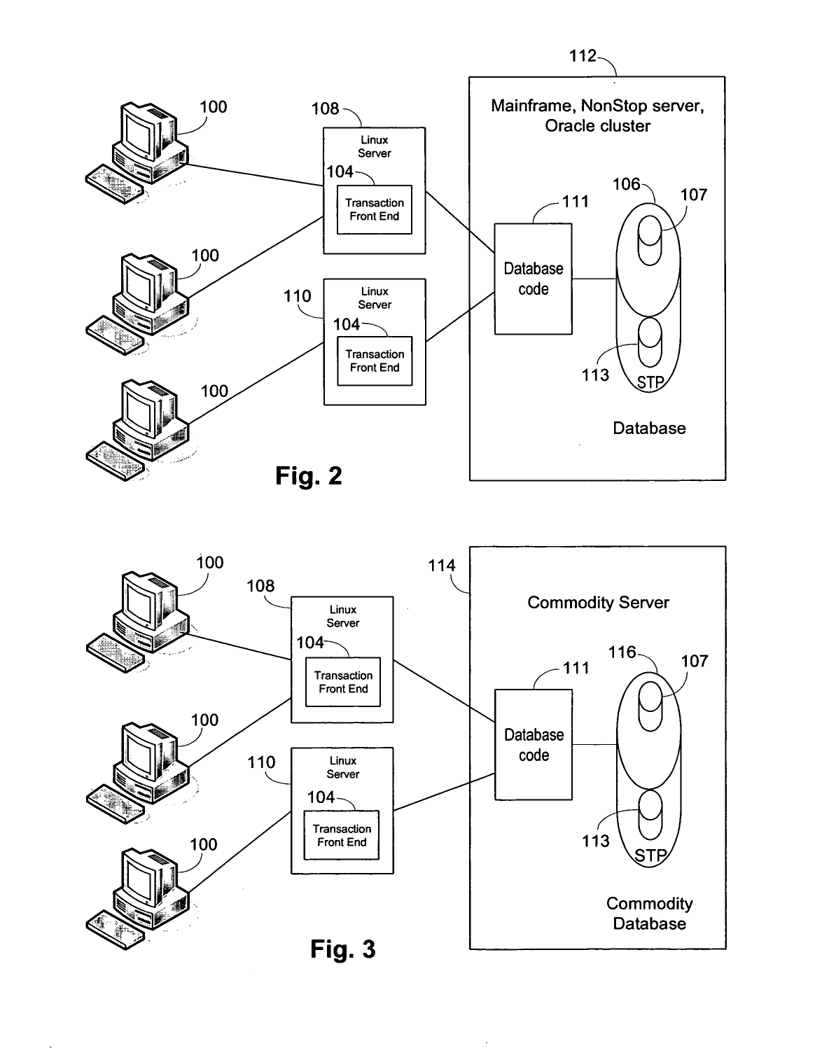

FIG. 3 is a second embodiment according to the present invention. Again clients 100 communicate with the commodity servers 108 and 110. However, in this case the mainframe 112 has been replaced by a commodity server 114, which instead of running the mainframe database 106 is running a commodity database 116 or similar, examples of which are MySQL, Postgres and SQL Server. Based on the operations of the commitment process according to the present invention, the reliability of the mainframe 112 is not required if the uptime requirements for the server 114 can otherwise be maintained, though it is understood that a mainframe environment may be appropriate due to other scalability, availability and maintainability considerations.

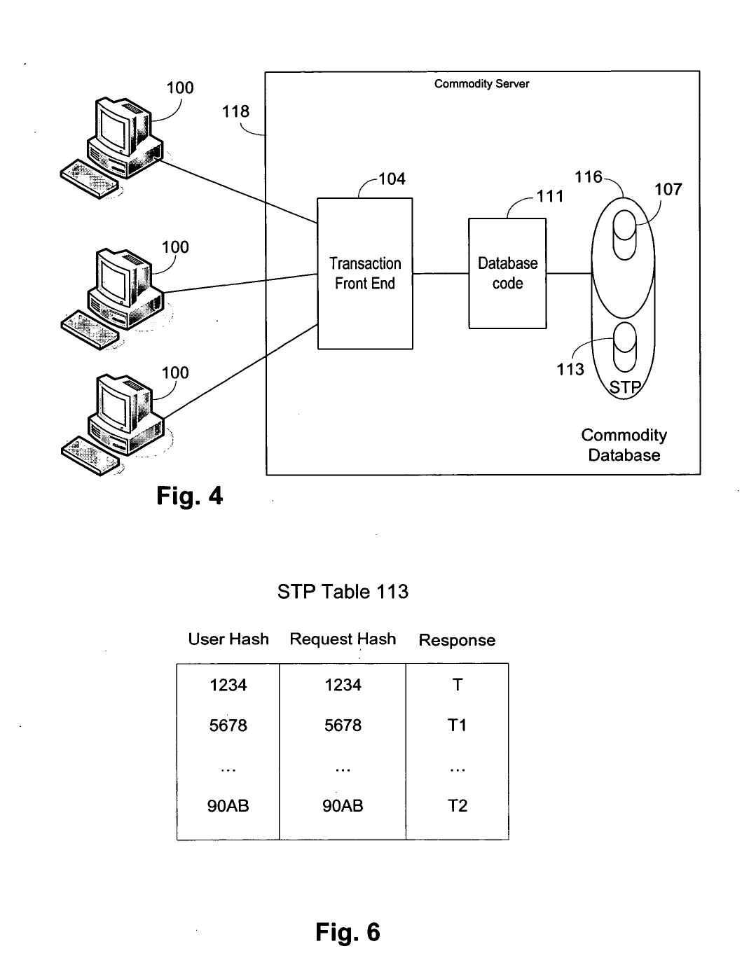

FIG. 4 illustrates a third embodiment according to the present invention. In this case the clients 100 are directly connected to a commodity server 118, which includes the transaction front-end module 104, the database code module 111 and the database 116. In this case only one server 118 is utilized as the number of clients 100 is sufficiently small that the communications requirements can be met without providing separate servers to perform the communication tasks. In a fully scaled environment with a very large number of clients, architectures as in FIG. 2 or FIG. 3 are preferred.

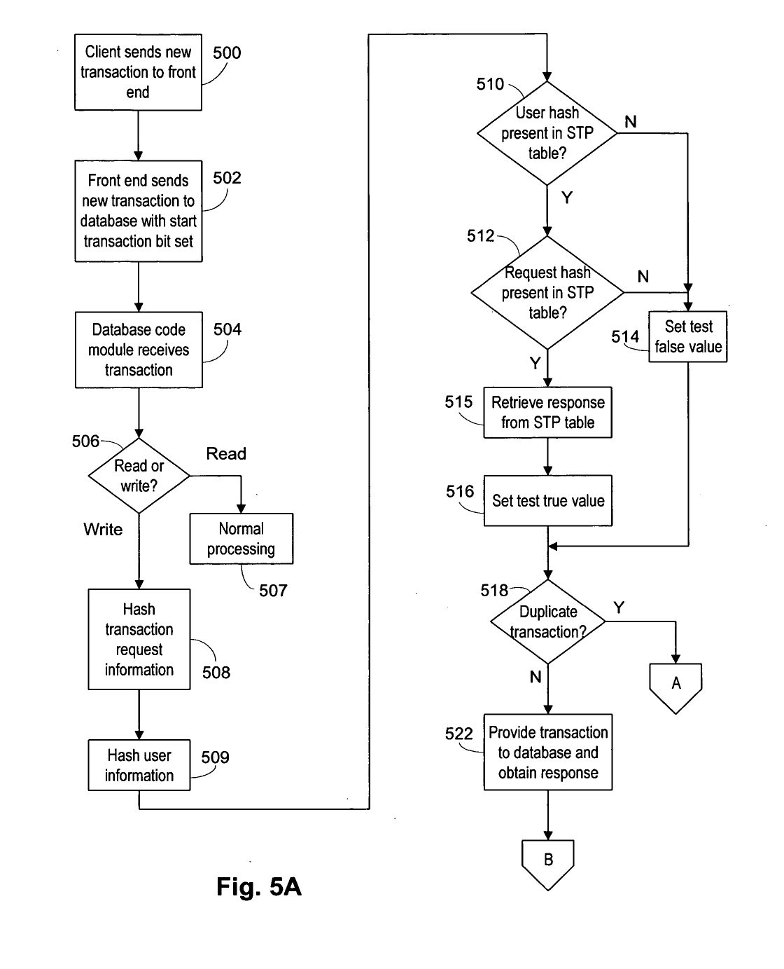

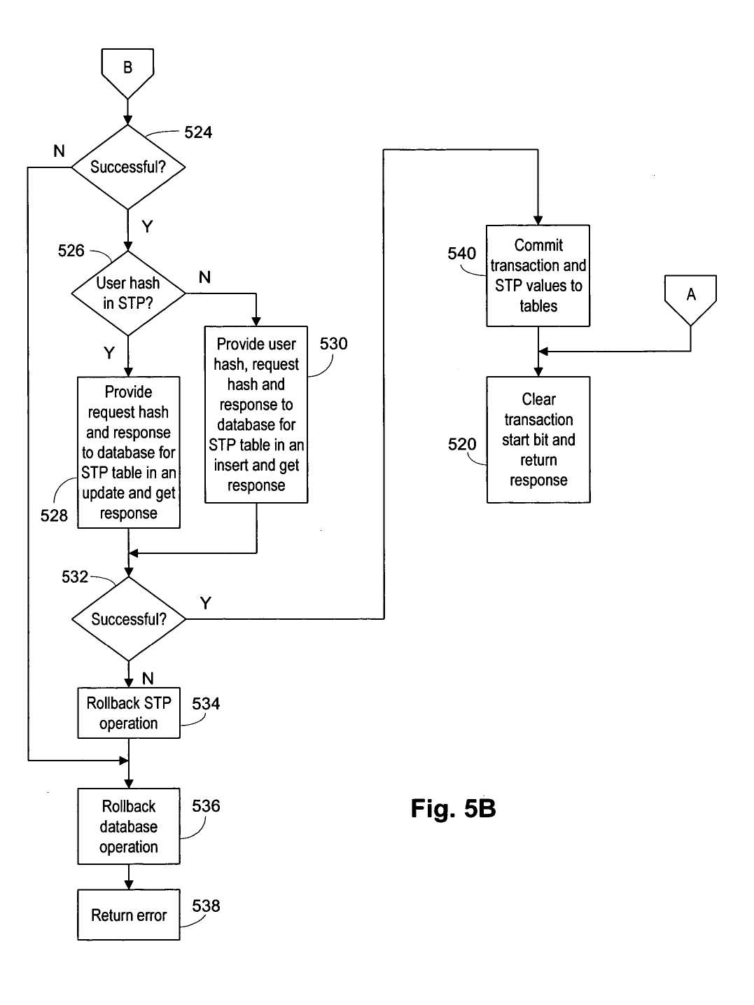

As described above, one of the major problems in a transaction system is the potential for double commitment of write transactions. In a system according to the present invention as shown in FIGS. 5A and 5B, a client 100 in step 500 provides a new transaction to a transaction front-end module 104. The transaction front-end module 104 then performs the necessary processing operations and provides this new transaction to the database code module 111, with the additional operation in step 502 that a start transaction bit is set to indicate that this is a new transaction. In step 504 the database code module 111 receives the transaction. The first operation of the database code module 111 is to determine in step 506 if this is a read or write transaction. If it is a read transaction, control proceeds to step 507 where normal processing according to the prior art is performed. The focus of the present invention is on write operations where the potential for double commit operations can occur.

If it is a write operation, control proceeds to step 508 where the request information in the transaction is hashed to provide a unique value. Preferably the request information includes the actual data which is to be placed into the database. This is preferably hashed into a 64 or 128 bit value to save space and provide a unique value representing the data. Control then proceeds to step 509, where the user information is similarly hashed. In the preferred embodiment the user information includes the user identification to allow user tracking, the table name or table names for which the operation or operations are being requested, and the particular columns in the table or tables which are being affected. If there are multiple tables or columns, each is provided as part of the task operation to provide a simple hash value. Similarly the request hash will be developed from each of the request values for each table and column. Again this is preferably hashed using various hashing techniques as desired into a 64 or 128 bit value. It is understood that the other values could be utilized if desired, such that both uniqueness is maintained and storage values are optimized. After the hashing is performed in step 510, control proceeds to step 512 to inspect the STP 113 table to determine if the user hash value is already present in the STP table 113. This is done by the database code module 111 providing a query to the database 106 or 116. This type of operation is performed in all similar cases and hereafter omitted for clarity. If so, control proceeds to step 512 to determine if the request hash is also present in the STP table 113. If the relevant hash is not present in step 510 or 512, control proceeds to step 514 where a test value is set to a false value. If the request hash is present in step 512, where the user hash has previously been determined to be present, this is an indication that the transaction which is attempting to be committed has actually already been committed and should not be recommitted, i.e., it is a duplicate transaction request. Control proceeds to step 515 to retrieve the response from the prior committed operation from the STP table 113. In step 516 the test value is set to true.

After steps 514 or 516, control proceeds to step 518 to determine if a duplicate transaction has been determined. If so, control proceeds to step 520 where the transaction start bit which has been set is cleared and the response, which in this case has been retrieved from the STP table 113, is returned to the transaction front-end module 104, which then returns it to the client 100.

If a duplicate transaction was not determined in step 518, control proceeds to step 522, where the transaction is actually provided to the database 106 or 116 and a response is received to indicate whether the operation by the database 106 or 116 has been successful. Control proceeds to step 524 to determine if the database 106 or 116 operation was successful. If so, then control proceeds to step 526 to determine if the user hash value is already present in the STP table 113. If so, control proceeds to step 528 where the request hash and response, which has been received from the database 106 or 116, are simply updated in the STP table 113. As the user hash is already present, the value that is there for the prior request hash and response value need only to be updated. However, if the user hash is not present, control proceeds to step 530 where the user hash value, the request hash value and the response are inserted into the STP table 113. After step 528 or 530 is completed, the response to the update or insert operation is evaluated in step 532. If the operation of providing the values to the STP table 113 was not successful, control proceeds to step 534 where the STP operation is rolled back. Control proceeds to step 536, which is also where a control will proceed from an unsuccessful insertion in step 524. In step 536 the database operation itself is rolled back so that both, in this case, the STP operation and the database operation itself, are never committed. Control proceeds to step 538, where an error is returned through the transaction front-end module 104 to the client 100. Normally the transaction would then be retried. If it is retried, there is no entry in the STP table 113 and no duplicate because they were not committed and therefore, it would be a normal retry response situation.

If the providing of the information to the STP table was successful in step 532, control proceeds to step 540 where a commit request is provided for both the transaction value itself and for the STP table 113 values. These are encapsulated in a single transaction to the database 106 or 116 so that a race condition will not develop. Thus in step 540 the database 106 or 116 actually commits the transaction request values and the STP table 113 values to their respective tables. Control proceeds to step 520 where the transaction is completed and the start bit cleared and a positive response is returned back.

Therefore, the STP table 113 is utilized to track the values of the last write transaction which was attempted by the particular user so that a double commitment operation cannot be developed. It is considered adequate for most circumstances to track only a single transaction from a given user in the STP table 110 as generally two transactions will not be outstanding from a single client. However, if desired, a multiple entry table can be used, with least recently used replacement techniques or the like used to update the table values for a given user.

FIG. 6 illustrates the preferred embodiment table structure for the STP table 113. A primary key is the user hash value, an alternate key is the request hash value and the third entry in each now is a response, i.e., the response that was provided from the database core when the transaction was originally committed.

Thus it can be seen that utilizing this process allows the transactions to be only singly committed, with no double commit capabilities, because should the transaction actually be committed and then there is a response loss any place in the system returning back to the client, and the client then immediately retries it, this duplicate commitment is detected and the response is simply reprovided without actually performing the full operation. This allows the transaction front-end, i.e., the component with the most scalability requirements, to be moved to commodity hardware without the need for clustering. Depending on other requirements, a mainframe or commodity server and related databases can be used in conjunction with the commodity hardware for the transaction front-end.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method for preventing double commitment of transactions from a client to a database, the method comprising:
providing a table to track committed transactions, the table including entries for a value identifying the transaction and a value indicating the response to committing the transaction;
providing a new transaction to the database to be committed and receiving a transaction response;
if a successful response is received when providing the new transaction, providing a value identifying the new transaction and the transaction response to the table and receiving a response;
if a successful response is received when providing the value identifying the new transaction and the transaction response to the table, committing both the new transaction to the database and the value identifying the new transaction and the transaction value to the table; and
providing the transaction response for delivery to the client after committing.

2. The method of claim 1, wherein the value identifying the new transaction is based on values identifying the user and values identifying the data in the new transaction.

3. The method of claim 2, wherein the value identifying the user is a hash of user identification, requested table in the database and requested column in the database.

4. The method of claim 2, wherein the value identifying the data in the new transaction is a hash of the data.

5. The method of claim 4, wherein the value identifying the user is a hash of user identification, requested table in the database and requested column in the database.

6. The method of claim 2, wherein providing a value identifying the new transaction to the table includes:
determining if a transaction having a value identifying the user which is same as the value identifying the user of the new transaction is present;
if such a transaction is present, providing the value identifying the data in the new transaction and the transaction response in an update operation; and
if such a transaction is not present, providing the value identifying the user and the value identifying the data in the new transaction and the transaction response in an insert operation

7. The method of claim 1, further comprising:
if the received response when providing the new transaction is unsuccessful, rolling back the transaction operation in the database;
if the received response when providing the value identifying the new transaction and the transaction response is unsuccessful, rolling back the operation to the table and the transaction operation in the database; and
if any roll backs occurred, providing an error response for delivery to the client after rolling back.

8. A method for preventing double commitment of transactions from a client to a database, the method comprising:
providing a table tracking committed transactions, the table including entries of a value identifying the transaction and a value indicating the response to committing the transaction;
receiving a new transaction from a client;
comparing entries in the table of values identifying transactions and a value identifying the new transaction; and
if there is a match between the value identifying the new transaction and a value in the table identifying a transaction, not providing the new transaction to be committed to the database.

9. The method of claim 8, further comprising:
if there is a match between the value identifying the new transaction and a value in the table identifying a transaction, providing the response associated with the transaction in the table for delivery to the client.

10. The method of claim 8, wherein the value identifying a transaction is based on values identifying the user and values identifying the data in the new transaction.

11. The method of claim 10, wherein the value identifying the user is a hash of user identification, requested table in the database and requested column in the database.

12. The method of claim 10, wherein the value identifying the data in the new transaction is a hash of the data.

13. The method of claim 12, wherein the value identifying the user is a hash of user identification, requested table in the database and requested column in the database.

14. A method for preventing double commitment of transactions from a client to a database, the method comprising:
providing a table to track committed transactions, the table including entries for a value identifying the transaction and a value indicating the response to committing the transaction;
receiving a new transaction from a client;
comparing entries in the table of values identifying transactions and a value identifying the new transaction;
if there is a match between the value identifying the new transaction and a value in the table identifying a transaction, not providing the new transaction to be committed to the database and providing the response associated with the transaction in the table for delivery to the client;
if there is not a match between the value identifying the new transaction and a value in the table identifying a transaction, providing the new transaction to the database to be committed and receiving a transaction response;
if a successful response is received when providing the new transaction, providing a value identifying the new transaction and the transaction response to the table and receiving a response;
if a successful response is received when providing the value identifying the new transaction and the transaction response to the table, committing both the new transaction to the database and the value identifying the new transaction and the transaction value to the table; and
providing the transaction response for delivery to the client after committing.

15. The method of claim 14, wherein the value identifying a transaction is based on values identifying the user and values identifying the data in the new transaction.

16. The method of claim 15, wherein the value identifying the user is a hash of user identification, requested table in the database and requested column in the database.

17. The method of claim 15, wherein the value identifying the data in the new transaction is a hash of the data.

18. The method of claim 17, wherein the value identifying the user is a hash of user identification, requested table in the database and requested column in the database.

19. The method of claim 15, wherein providing a value identifying the new transaction to the table includes:
determining if a transaction having a value identifying the user which is same as the value identifying the user of the new transaction is present;
if such a transaction is present, providing the value identifying the data in the new transaction and the transaction response in an update operation; and
if such a transaction is not present, providing the value identifying the user and the value identifying the data in the new transaction and the transaction response in an insert operation

20. The method of claim 14, further comprising:
if the received response when providing the new transaction is unsuccessful, rolling back the transaction operation in the database;
if the received response when providing the value identifying the new transaction and the transaction response is unsuccessful, rolling back the operation to the table and the transaction operation in the database; and
if any roll backs occurred, providing an error response for delivery to the client after rolling back.

21. A system for preventing double commitment of transactions from a client to a database with a front-end module performing communication with the client, the system comprising:
a database server coupled to the commodity server and including a database code module coupled to the front-end module and a database coupled to the database code module,
wherein the database includes a table to track committed transactions, the table including entries for a value identifying the transaction and a value indicating the response to committing the transaction; and
wherein the database code module:
provides a new transaction to the database to be committed and receives a transaction response;
if a successful response is received when providing the new transaction, provides a value identifying the new transaction and the transaction response to the table and receives a response;
if a successful response is received when providing the value identifying the new transaction and the transaction response to the table, commits both the new transaction to the database and the value identifying the new transaction and the transaction value to the table; and
provides the transaction response for delivery to the front-end module after committing.

22. The system of claim 21, wherein the database server is a commodity server.

23. The system of claim 21, wherein the database server is one of a mainframe, a NonStop server, or an Oracle cluster.

24. The system of claim 21, the system further comprising:
a commodity server for coupling to the client and receiving a new transaction from the client, the commodity server including the front-end module and being coupled to the database server.

25. The system of claim 21, wherein there are a plurality of clients, the system further comprising:
a plurality of commodity servers for coupling to the plurality of clients and receiving new transactions from the plurality of clients, each of the plurality of commodity servers including a front-end module to perform communications with at least a portion of the plurality of clients, where the plurality of clients are distributed among the plurality of commodity servers,
wherein the database server is coupled to each of the plurality of commodity servers and the database code module is coupled to each of the front-end modules.

26. The system of claim 21, wherein the value identifying the new transaction is based on values identifying the user and values identifying the data in the new transaction.

27. The system of claim 26, wherein the value identifying the user is a hash of user identification, requested table in the database and requested column in the database.

28. The system of claim 26, wherein the value identifying the data in the new transaction is a hash of the data.

29. The system of claim 28, wherein the value identifying the user is a hash of user identification, requested table in the database and requested column in the database.

30. The system of claim 26, wherein providing a value identifying the new transaction to the table includes:
determining if a transaction having a value identifying the user which is same as the value identifying the user of the new transaction is present;
if such a transaction is present, providing the value identifying the data in the new transaction and the transaction response in an update operation; and
if such a transaction is not present, providing the value identifying the user and the value identifying the data in the new transaction and the transaction response in an insert operation

31. The system of claim 25, wherein the database code module further:
if the received response when provides the new transaction is unsuccessful, rolling back the transaction operation in the database;
if the received response when providing the value identifying the new transaction and the transaction response is unsuccessful, requests a rolling back of the operation to the table and the transaction operation in the database; and
if any roll backs occurred, provides an error response to the client after rolling back.

32. A system for preventing double commitment of transactions from a client to a database with a front-end module performing communication with the client, the system comprising:
a database server coupled to the commodity server and including a database code module coupled to the front-end module and a database coupled to the database code module,
wherein the database includes a table tracking committed transactions, the table including entries of a value identifying the transaction and a value indicating the response to committing the transaction; and
wherein the database code module:
receives a new transaction from a client;
compares entries in the table of values identifying transactions and a value identifying the new transaction; and
if there is a match between the value identifying the new transaction and a value in the table identifying a transaction, does not provide the new transaction to be committed to the database.

33. The system of claim 32, wherein the database code module further:
if there is a match between the value identifying the new transaction and a value in the table identifying a transaction, provides the response associated with the transaction in the table for delivery to the front-end module.

34. The system of claim 32, wherein the value identifying a transaction is based on values identifying the user and values identifying the data in the new transaction.

35. The system of claim 34, wherein the value identifying the user is a hash of user identification, requested table in the database and requested column in the database.

36. The system of claim 34, wherein the value identifying the data in the new transaction is a hash of the data.

37. The system of claim 36, wherein the value identifying the user is a hash of user identification, requested table in the database and requested column in the database.

38. The system of claim 32, the system further comprising:
a commodity server for coupling to the client and receiving a new transaction from the client, the commodity server including the front-end module and being coupled to the database server.

39. The system of claim 32, wherein there are a plurality of clients, the system further comprising:
a plurality of commodity servers for coupling to the plurality of clients and receiving new transactions from the plurality of clients, each of the plurality of commodity servers including a front-end module to perform communications with at least a portion of the plurality of clients, where the plurality of clients are distributed among the plurality of commodity servers,
wherein the database server is coupled to each of the plurality of commodity servers and the database code module is coupled to each of the front-end modules.

40. A system for preventing double commitment of transactions from a client to a database with a front-end module performing communication with the client, the system comprising:
a database server coupled to the commodity server and including a database code module coupled to the front-end module and a database coupled to the database code module,
wherein the database includes a table to track committed transactions, the table including entries for a value identifying the transaction and a value indicating the response to committing the transaction; and
wherein the database code module:
receives a new transaction from a client;
compares entries in the table of values identifying transactions and a value identifying the new transaction;
if there is a match between the value identifying the new transaction and a value in the table identifying a transaction, does not provide the new transaction to be committed to the database and provides the response associated with the transaction in the table to the client;
if there is not a match between the value identifying the new transaction and a value in the table identifying a transaction, provides the new transaction to the database to be committed and receives a transaction response;
if a successful response is received when providing the new transaction, provides a value identifying the new transaction and the transaction response to the table and receives a response;
if a successful response is received when providing the value identifying the new transaction and the transaction response to the table, commits both the new transaction to the database and the value identifying the new transaction and the transaction value to the table; and
provides the transaction response for delivery to the front-end module after committing.

41. The system of claim 40, wherein the value identifying a transaction is based on values identifying the user and values identifying the data in the new transaction.

42. The system of claim 41, wherein the value identifying the user is a hash of user identification, requested table in the database and requested column in the database.

43. The system of claim 41, wherein the value identifying the data in the new transaction is a hash of the data.

44. The system of claim 43, wherein the value identifying the user is a hash of user identification, requested table in the database and requested column in the database.

45. The system of claim 41, wherein providing a value identifying the new transaction to the table includes:
determining if a transaction having a value identifying the user which is same as the value identifying the user of the new transaction is present;
if such a transaction is present, providing the value identifying the data in the new transaction and the transaction response in an update operation; and
if such a transaction is not present, providing the value identifying the user and the value identifying the data in the new transaction and the transaction response in an insert operation

46. The system of claim 40, wherein the database code module further:
if the received response when providing the new transaction is unsuccessful, requests a rolling back of the transaction operation in the database;
if the received response when providing the value identifying the new transaction and the transaction response is unsuccessful, requests a rolling back of the operation to the table and the transaction operation in the database; and
if any roll backs occurred, provides an error response for delivery to the client after rolling back.

47. The system of claim 40, the system further comprising:
a commodity server for coupling to the client and receiving a new transaction from the client, the commodity server including the front-end module and being coupled to the database server.

48. The system of claim 40, wherein there are a plurality of clients, the system further comprising:
a plurality of commodity servers for coupling to the plurality of clients and receiving new transactions from the plurality of clients, each of the plurality of commodity servers including a front-end module to perform communications with at least a portion of the plurality of clients, where the plurality of clients are distributed among the plurality of commodity servers,
wherein the database server is coupled to each of the plurality of commodity servers and the database code module is coupled to each of the front-end modules.

49. A computer readable medium or media having computer-executable instructions stored therein for an application which performs the following method for preventing double commitment of transactions from a client to a database, the method comprising:
providing a table to track committed transactions, the table including entries for a value identifying the transaction and a value indicating the response to committing the transaction;
providing a new transaction to the database to be committed and receiving a transaction response;
if a successful response is received when providing the new transaction, providing a value identifying the new transaction and the transaction response to the table and receiving a response;
if a successful response is received when providing the value identifying the new transaction and the transaction response to the table, committing both the new transaction to the database and the value identifying the new transaction and the transaction value to the table; and
providing the transaction response for delivery to the client after committing.

50. The computer readable medium or media of claim 49, wherein the value identifying the new transaction is based on values identifying the user and values identifying the data in the new transaction.

51. The computer readable medium or media of claim 50, wherein the value identifying the user is a hash of user identification, requested table in the database and requested column in the database.

52. The computer readable medium or media of claim 50, wherein the value identifying the data in the new transaction is a hash of the data.

53. The computer readable medium or media of claim 52, wherein the value identifying the user is a hash of user identification, requested table in the database and requested column in the database.

54. The computer readable medium or media of claim 50, wherein providing a value identifying the new transaction to the table includes:
determining if a transaction having a value identifying the user which is same as the value identifying the user of the new transaction is present;
if such a transaction is present, providing the value identifying the data in the new transaction and the transaction response in an update operation; and
if such a transaction is not present, providing the value identifying the user and the value identifying the data in the new transaction and the transaction response in an insert operation

55. The computer readable medium or media of claim 49, the method further comprising:
if the received response when providing the new transaction is unsuccessful, rolling back the transaction operation in the database;
if the received response when providing the value identifying the new transaction and the transaction response is unsuccessful, rolling back the operation to the table and the transaction operation in the database; and
if any roll backs occurred, providing an error response for delivery to the client after rolling back.

56. A computer readable medium or media having computer-executable instructions stored therein for an application which performs the following method for preventing double commitment of transactions from a client to a database, the method comprising:
providing a table tracking committed transactions, the table including entries of a value identifying the transaction and a value indicating the response to committing the transaction;
receiving a new transaction from a client;
comparing entries in the table of values identifying transactions and a value identifying the new transaction; and
if there is a match between the value identifying the new transaction and a value in the table identifying a transaction, not providing the new transaction to be committed to the database.

57. The computer readable medium or media of claim 56, the method further comprising:
if there is a match between the value identifying the new transaction and a value in the table identifying a transaction, providing the response associated with the transaction in the table for delivery to the client.

58. The computer readable medium or media of claim 56, wherein the value identifying a transaction is based on values identifying the user and values identifying the data in the new transaction.

59. The computer readable medium or media of claim 58, wherein the value identifying the user is a hash of user identification, requested table in the database and requested column in the database.

60. The computer readable medium or media of claim 58, wherein the value identifying the data in the new transaction is a hash of the data.

61. The computer readable medium or media of claim 60, wherein the value identifying the user is a hash of user identification, requested table in the database and requested column in the database.

62. A computer readable medium or media having computer-executable instructions stored therein for an application which performs the following method for preventing double commitment of transactions from a client to a database, the method comprising:
providing a table to track committed transactions, the table including entries for a value identifying the transaction and a value indicating the response to committing the transaction;
receiving a new transaction from a client;
comparing entries in the table of values identifying transactions and a value identifying the new transaction;
if there is a match between the value identifying the new transaction and a value in the table identifying a transaction, not providing the new transaction to be committed to the database and providing the response associated with the transaction in the table for delivery to the client;
if there is not a match between the value identifying the new transaction and a value in the table identifying a transaction, providing the new transaction to the database to be committed and receiving a transaction response;
if a successful response is received when providing the new transaction, providing a value identifying the new transaction and the transaction response to the table and receiving a response;
if a successful response is received when providing the value identifying the new transaction and the transaction response to the table, committing both the new transaction to the database and the value identifying the new transaction and the transaction value to the table; and
providing the transaction response for delivery to the client after committing.

63. The computer readable medium or media of claim 62, wherein the value identifying a transaction is based on values identifying the user and values identifying the data in the new transaction.

64. The computer readable medium or media of claim 63, wherein the value identifying the user is a hash of user identification, requested table in the database and requested column in the database.

65. The computer readable medium or media of claim 63, wherein the value identifying the data in the new transaction is a hash of the data.

66. The computer readable medium or media of claim 65, wherein the value identifying the user is a hash of user identification, requested table in the database and requested column in the database.

67. The computer readable medium or media of claim 63, wherein providing a value identifying the new transaction to the table includes:
determining if a transaction having a value identifying the user which is same as the value identifying the user of the new transaction is present;
if such a transaction is present, providing the value identifying the data in the new transaction and the transaction response in an update operation; and
if such a transaction is not present, providing the value identifying the user and the value identifying the data in the new transaction and the transaction response in an insert operation

68. The computer readable medium or media of claim 62, the method further comprising:
if the received response when providing the new transaction is unsuccessful, rolling back the transaction operation in the database;
if the received response when providing the value identifying the new transaction and the transaction response is unsuccessful, rolling back the operation to the table and the transaction operation in the database; and
if any roll backs occurred, providing an error response for delivery to the client after rolling back.
